(19) United States
(12) Patent Application Publication
(10) Pub. No.: US 2006/0193337 A1
(43) Pub. Date: Aug. 31, 2006

(54) Device management broadcast operation

(76) Inventors: Toni Paila, Degerby (FI); Janne Vento, Tampere (FI)

Correspondence Address: MORGAN & FINNEGAN, LLP, 3 World Financial Center, New York, NY, 10281-2101, US

(21) Appl. No.: 11/065,031

(22) Filed: Feb. 25, 2005

(51) Int. Cl. H04L 12/28

(52) U.S. Cl. 370/432; 370/390

(57) ABSTRACT

An indication of a device management broadcast is received. This device management broadcast is in the form of a file delivery session, such as a FLUTE session. Further, a transport object of the device management broadcast is received. This transport object may include one or more device management messages in compressed or uncompressed form. Moreover, the indication of the broadcast may be received in various forms. Examples of such forms include an electronic service guide (ESG), one or more short messaging service (SMS) messages, and/or one or more session description protocol (SDP) messages.

### FIELD OF THE INVENTION

The present invention relates to communications. More particularly, the present invention relates to device management techniques.

### BACKGROUND OF THE INVENTION

Delivering content to terminal devices in digital format is becoming increasingly commonplace. Such content may include, for example, text, images, audio, video, and multimedia delivered over broadcast transmission media. Examples of such broadcast transmission media include digital video broadcast handheld (DVB-H), DVB terrestrial (DVB-T), cable networks, networks, Terrestrial Digital Multimedia Broadcast (T-DMB), Satellite Digital Multimedia Broadcast (S-DMB), Terrestrial Digital Audio Broadcasting (T-DAB), 3GPP Multimedia Broadcast/Multicast Service (MBMS), 3GPP2 Broadcast/Multicast Service (BCMCS), Wireless LAN (WLAN), WiMAX and Qualcomm Forward Link Only (FLO).

Device management (DM) refers to the configuration of a mobile device by third parties on behalf of the mobile device's user. Examples of such third parties include wireless operators, service providers, and information management departments within business organizations. Device management may encompass a variety of configuration operations. For instance, the third party may remotely establish operational parameters for the mobile device, diagnose and service mobile devices, as well as install or upgrade mobile device software, oe components of the software.

As Internet Protocol (IP) based mobile broadcast services are emerging, it is uncertain how to distribute a DM messages to terminal devices via broadcast channel(s). In addition, it is also uncertain how to distribute such information in a unidirectional environment, where a return channel to DM servers is typically unavailable, or when use of such a return channel is either forbidden or strongly discouraged due to possible uplink congestion problems.

This problem is especially highlighted in the delivery of large objects having multiple messages. A typical solution for this situation involves delivery the large object message by message. Upon successful delivery of a particular message, the client (terminal device) acknowledges its receipt to the originating device. In broadcast environments, this technique is inefficient. Moreover, as indicated above, the transmission of upstream acknowledgments may not be possible in many environments. Accordingly, techniques are needed for the delivery of device management information to terminal devices.

### SUMMARY OF THE INVENTION

The present invention provides techniques for the delivery of device management information, such as open mobile alliance (OMA) file management (FM) messages. According to an aspect of the present invention, an indication of a device management broadcast is received. This device management broadcast is in the form of a file delivery session, such as a FLUTE session. Further, a transport object of the device management broadcast is received. This transport object may include one or more device management messages in compressed or uncompressed form. Moreover, according to aspects of the present invention, the indication of the broadcast may be received in various forms. Examples of such forms include an electronic service guide (ESG), one or more short messaging service (SMS) messages, and/or one or more session description protocol (SDP) messages.

The received device management messages may be stored in a terminal device. Accordingly, these steps may be performed by a terminal device. Moreover, aspects of the present invention provide program code (e.g., a computer program product) to instruct a processor to perform these steps.

In yet further aspects of the present invention, one or more device management messages are generated and grouped in a file delivery session (e.g., a FLUTE session). This session may then be delivered to one or more terminal devices. Moreover, an indication of the file delivery session may be provided to the one or more terminal devices. As stated above, this indication may be in various forms, such as an electronic service guide (ESG), one or more short messaging service (SMS) messages, and/or one or more session description protocol (SDP) messages. Additionally, one or more of the device management messages may be compressed.

These steps may be performed by one or more devices. Moreover, aspects of the present invention provide program code to instruct a processor to perform these steps.

Further features and advantages of the present invention will become apparent from the following description, claims, and accompanying drawings.

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a diagram of an operational environment according to embodiments of the present invention;

FIG. 2 is a block diagram providing an overview of device management delivery according to aspects of the present invention;

FIG. 3A and 3B are diagrams of exemplary ALC encapsulations according to aspects of the present invention;

FIG. 4A is a block diagram showing an exemplary terminal device implementation;

FIG. 4B is a block diagram showing an exemplary device management system implementation;

FIGS. 5, 6, and 7 are flowcharts illustrating sequences of operational steps according to aspects of the present invention; and

FIG. 8 is a diagram of an exemplary computer system.

### DETAILED DESCRIPTION OF THE PREFERRED EMBODIMENTS

I. Operational Environment

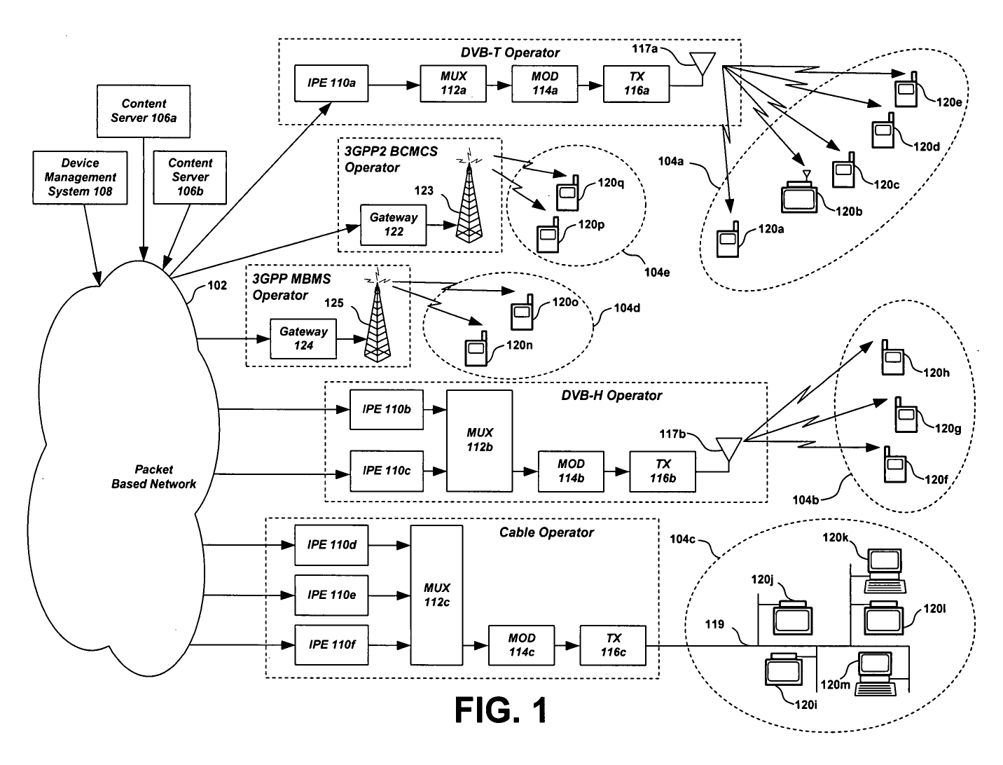

FIG. 1 is a diagram of a broadcast environment in which the present invention may be employed. This environment involves a packet-based network 102 and multiple broadcast networks 104. These networks provide for the delivery of information to terminal devices 120.

Packet-based network 102 performs communications through the exchange of packets, such as Internet Protocol (IP) packets, through various protocols. Accordingly, network 102 may be of various types. For example, network 102 may include local area network(s) (e.g., Ethernets), and/or the Internet.

Broadcast networks 104 provide point-to-multipoint type communications over a broadcast transmission medium. Each broadcast network may employ various wired or wireless technologies. For instance, FIG. 1 shows a broadcast network 104a that is a DVB-T network, and a broadcast network 104b that is a DVB-H network. In addition, FIG. 1 shows a broadcast network 104c that is a cable network, such as a Data Over Cable Service Interface Specification (DOCSIS) network. Also, FIG. 1 shows a 3GPP MBMS network 104d, as well as a 3GPPS BCMCS network 104e. Networks 104a, 104b, 104d, and 104e transmit wireless signals that may be received by devices within coverage areas.

The environment of FIG. 1 includes a plurality of content servers 106 that are coupled to packet-based network 102. Servers 106 deliver content such as audio, video, text, images, and or multimedia. For example, a particular server 106 may provide multiple audio streams via multiple audio channels. In addition, this server may provide text streams that are synchronized with corresponding audio streams.

Moreover, servers 106 may deliver information regarding content offierings. This information may be in the form of electronic service guides (ESGs), short messaging service (SMS) messages, and the like.

In addition to content servers 106, the environment of FIG. 1 includes a device management system 108. This system delivers configuration information to devices. This information and its manner of delivery may be according to one or more device management protocols. Examples of such protocols include Open Mobile Alliance (OMA) device management.

Servers 106 and management system 108 may distribute their streams to one or more destinations across packet-based network 102. Such distribution may involve IP multicasting protocols. The combined bit rate of all streams produced by a particular server typically varies over time. In embodiments, these variations are around a stable average.

FIG. 1 shows multiple IP encapsulators (IPEs) 110 that are each coupled to packet-based network 102. IPEs 110 receive packet streams produced by servers 106 and 108 and operate as gateways between packet-based network 102 and broadcast networks 104. In particular, IPEs 110 convert received packet streams into broadcast network transport streams (e.g., DVB-H transport streams, and DVB-T transport streams).

For each broadcast network 104, FIG. 1 shows a multiplexer (MUX) 112, a modulator (MOD) 114, and a transmitter (TX) 116. In particular, FIG. 1 shows a MUX 112a, a MOD 114a, and a TX 116a corresponding to broadcast network 104a, a MUX 112b, a MOD 114b, and a TX 116b corresponding to broadcast network 104b, and a MUX 112c, a MOD 114c, and a TX 116c corresponding to broadcast network 104c. As shown in FIG. 1, each MUX 112 may be coupled to one or more IPEs 110. Also, each MOD 114 is coupled between its corresponding MUX 112 and TX 116.

Each multiplexer 112 combines transport streams from one or more different sources (such as different IPEs 110) into a single transmission stream. This single stream is sent to the coupled modulator 114, which converts the transmission stream from a digital representation into a radio frequency (RF) signal. The coupled transmitter (TX) 116 amplifies the RF signal and transmits it (or broadcasts) the signal to the devices in the corresponding broadcast network 104. For broadcast networks 104a and 104b, antennas 117a and 117b allow such transmissions to propagate wirelessly. However, for broadcast network 104c, such transmissions propagate through a cable medium 119.

FIG. 1 shows that broadcast networks 104 include one or more terminal devices 120. These devices receive and process RF signals transmitted by TXs 116. This allows the devices to present the services (e.g., streams) conveyed by the RF signals to its end-users. As shown in FIG. 1, devices 120 may include portable handheld devices (such as wireless telephones and PDAs), as well as televisions, set-top boxes, and personal computers.

In addition, broadcast networks 104 may include other devices, such as repeaters and monitors (not shown). A repeater (REP) receives an RF signal from a TX 116, amplifies it, and transmits it again, either on the same frequency or a different frequency. A monitor (MON) is a special receiver having the sole purpose of monitoring RF signals received from a transmitter 116 and providing alarms to the operator of the corresponding broadcast network 104.

For network 104d, FIG. 1 shows a gateway 122 and a base station 123. Similarly, for network 104e, FIG. 1 shows a gateway 124 and a base station 125. These components provide for the distribution of information (through wireless transmissions) to terminal devices 120n-120q.

II. Device Management

As described above, device management system 108 delivers device management information to terminal devices 120. Examples of such information include data to configure browser and wireless access protocol (WAP) settings for one or more terminal devices.

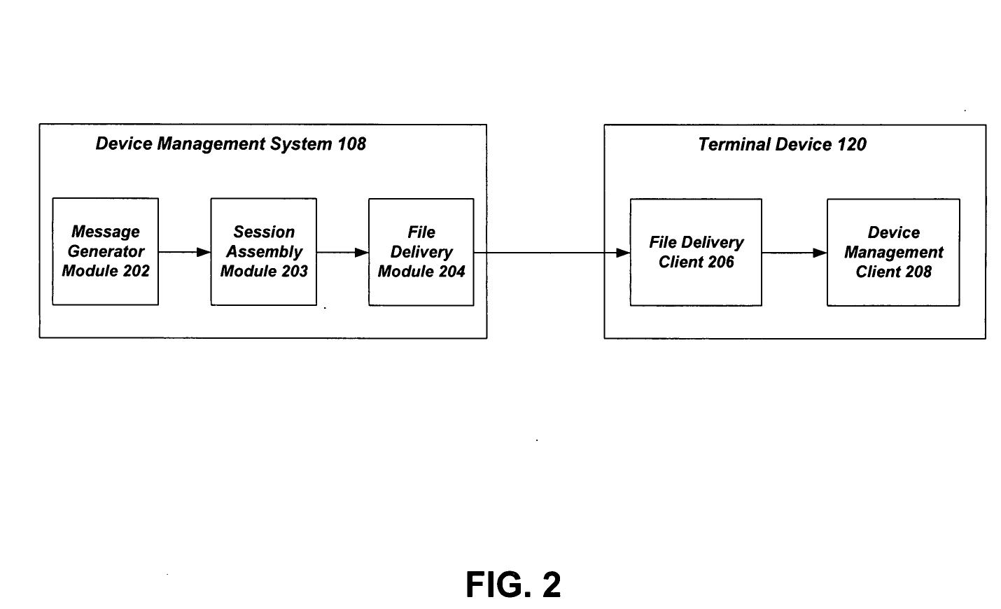

According to embodiments of the present invention, such delivery may employ file delivery protocols such as ALC and FLUTE. Accordingly, FIG. 2 is a block diagram providing an overview of such delivery. In particular, this diagram illustrates an interaction between device management system 108 and one of terminal devices 120.

As shown in FIG. 2, device management system 108 includes a message generator module 202, a session assembly module 203, and a file delivery module 204. Device management server 202 generates DM messages (e.g., OMA DM messages) that are intended for one or more terminal devices (such as terminal devices 120). Each of these messages may be directed at various management operations, such as remotely establishing operational parameters for the terminal devices, diagnosing and servicing terminal devices, as well as installing or upgrading mobile device software.

Session assembly module 203 receives one or more DM messages from module 202 and groups them into sessions, such as FLUTE sessions. Such sessions may be applicable to one or more terminal devices. For instance, a session may be intended for terminal devices grouped according to terminal model, host operator, and the like. To make this session known, file delivery module 204 may publish sessions to content servers (e.g., servers 106) that provide information to terminal devices in the form of ESGs, SMS messages, XML-based structures, session description protocol (SMS) messages, etc. This information can also be made available so that terminal devices fetch the information through return channel, if available.

File delivery module 204 delivers (e.g., transmits) sessions that were assembled by module 203 to one or more terminal devices. With reference to the environment of FIG. 1, this delivery may be across a packet network (such as network 102), and one or more further networks (such as network(s) 104).

The terminal device 120 depicted in FIG. 2 includes a file delivery client 206 and a device management client 208. File delivery client 206 receives transport objects associated with sessions generated by file delivery module 204. These transport objects convey one or more device management messages. Device management client 208 obtains such messages from client 206 and employs them with the terminal device accordingly.

As described above, device management messages may be delivered to terminal devices in the form of FLUTE files. FLUTE involves other protocols (e.g., ALC and LCT) to deliver such files (or objects) using packets, such as Internet protocol (IP) datagrams. A description of FLUTE, ALC, and LCT is now described.

III. ALC/LCT/FLUTE

ALC provides congestion controlled reliable asynchronous delivery of content to an unlimited number of concurrent receivers from a single sender. This is performed by utilizing a Layered Coding Transport (LCT) building block, a multiple rate congestion control building block, and a Forward Error Correction (FEC) building block. ALC is designed to be used with the IP multicast network service and does not require feedback packets from receivers to the sender. Information, referred to as objects, is transferred from a sender to one or more receivers in an ALC session.

ALC can support several different reliable content delivery service models. One such model is called the push service model. The push model involves the concurrent delivery of objects to a selected group of receivers. Another model is called the on-demand content delivery service model. In this model, a sender transmits an object (e.g., software) for a time period. During this time period, receivers may join the session and recover the object. This time period may be much longer in duration than the time required for a receiver to download the object. Thus, receivers join the session during such a time period and leave the session when they have received enough packets to recover the object. Such sessions are identified by a session description, which may be obtained, for example, through a web server.

ALC uses a packet format that includes a user datagram protocol (UDP) header followed by an LCT header, an FEC payload ID, and a packet payload.

LCT provides transport level support for reliable content delivery and stream delivery protocols. An LCT session includes one or more related LCT channels that originate at a single sender. The channels are used for a period of time to convey packets containing LCT headers. These packets may be received by one or more receivers. Although LCT requires a connection from a sender to receiver(s), it does not require a connection from the receiver(s) to the sender. Accordingly, LCT may be used for both unicast and multicast delivery.

The LCT header includes various fields. For instance, a CCI field is used to carry congestion control information, such as layer numbers, logical channel numbers, and sequence numbers. The CCI field may include various elements, such as a packet sequence number (PSN) that is incremented between each consecutive ALC/LCT packet, a current time slot index (CTSI) that is incremented periodically with a constant time interval, and a channel number (CN) that conveys a label varying within the range of at most 255 different values. In embodiments of the present invention, these fields may be handled by an ROHC mechanism.

As described above, ALC utilizes LCT as a building block. Accordingly, the ALC header includes the LCT fields, as well as an FEC payload ID field. FEC payload ID field identifies the encoding symbol(s) in the payload of the packet.

FLUTE is a protocol that builds on ALC to provide for the unidirectional delivery of files over the Internet. In particular, FLUTE provides for the signaling and mapping of properties of files to ALC concepts so that receivers may assign those parameters for received objects. According to FLUTE, files may be transferred to one or more receivers during a file delivery session. These files may include file delivery tables. A file delivery table describes various attributes associated with a particular file. For a given file, examples of such attributes include a transport object identifier (TOI) value representing the file, forward error correction encoding information, file location, file name, MIME media type of the file, size of the file, and encoding of the file.

To start receiving a file delivery session, the receiver obtains transport parameters associated with the session. The receiver then joins the session's channel(s) to receive ALC/LCT packets associated with the session. These ALC/LCT packets are demultiplexed according to their object identifiers and stored so that the corresponding files may be recovered. At least one of these files is an FDT, which is stored in the receiver's FDT database. When other files are received, the receiver accesses its FDT database to assign properties according to the corresponding FDT database entry.

The FLUTE header includes various fields. These fields include the LCT and ALC header fields. In addition, the FLUTE header includes an FEC Object Transmission Information Extension portion, an FDT Instance Extension portion, and an FDT Instance Compression Extension portion.

The FDT Instance Extension portion is used to indicate the transmission of FDT information. The FEC Object Transmission Information Extension portion is used to convey FEC coding information, such as the employed FEC coding method.

IV. ALC/FLUTE Encapsulation of Device Management Information

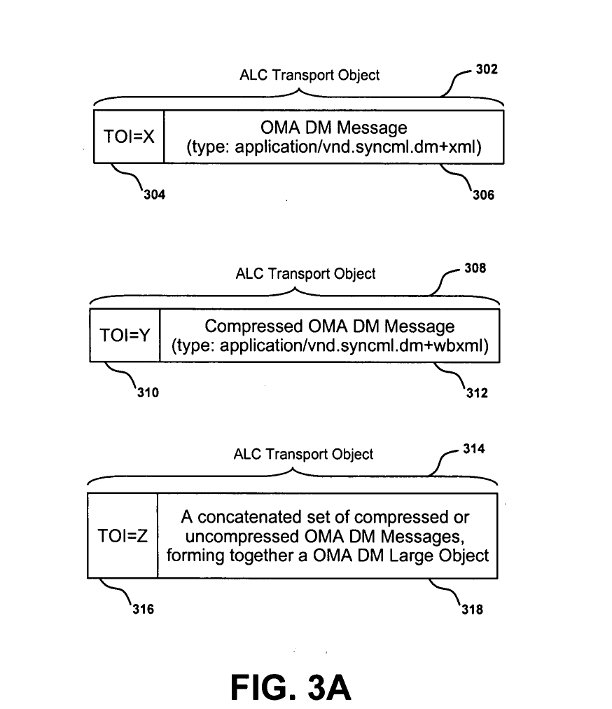

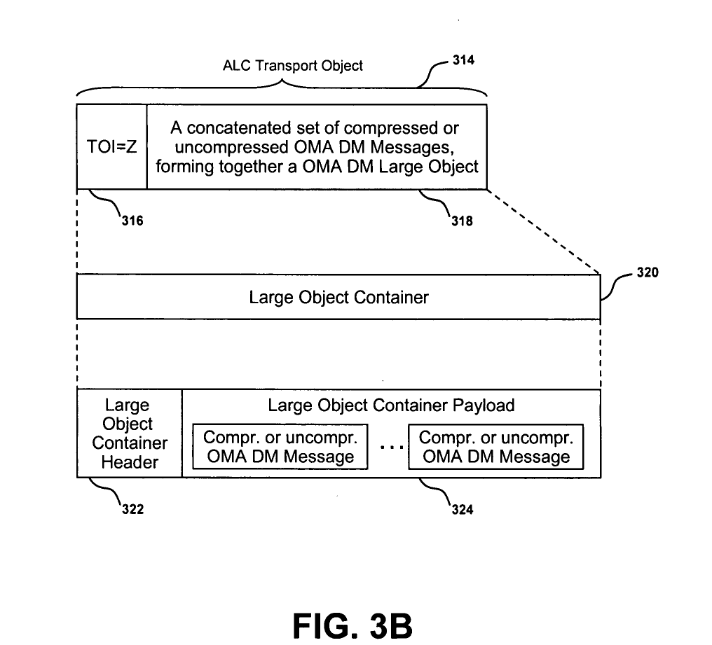

FIGS. 3A and 3B provide diagrams of exemplary transport objects according to aspects of the present invention. In particular, FIG. 3A illustrates a first ALC transport object 302 that conveys an OMA DM message, a second ALC transport object 308 that conveys a compressed OMA DM message, and a third ALC transport object 314 that conveys a concatenated set of compressed or uncompressed OMA DM messages. Further, FIG. 3B illustrates third transport object 314 in greater detail.

Each of objects 302, 308, and 314 are associated with a particular file delivery session. Accordingly, these objects are listed in a corresponding file delivery table (not shown). In this table, each of objects 302, 308, and 314 has a respective TOI value. For purposes of illustration, the TOI values of “X”, “Y”, and “Z” are assigned to objects 302, 308, and 314, respectively.

As shown in FIG. 3A, ALC transport object 302 includes a TOI indicator 304 and an OMA DM message 306. This object's corresponding FLUTE FDT entry is represented as:

<?xml version=″1.0″ encoding=″UTF-8″?>
<FDT-Instance xmlns:xsi=″http://www.w3.org/2001/XMLSchema-instance″
xmlns:fl=″http://www.example.com/flute″
xsi:schemaLocation=″http://www.example.com/flute-fdt.xsd“ Expires=″2890842807″>

<File

Content-Location=″http://www.operator.com/config/browser-settings.dm″
TOI=″X″
Content-Type=″application/vnd.syncml.dm+xml″
Content-Length=″6100″/>

... other File-elements ...

</FDT-Instance>

ALC transport object 308 includes a TOI indicator 310 and a compressed OMA DM message 312. This object's corresponding FLUTE FDT entry is represented as:

<?xml version=″1.0″ encoding=″UTF-8″?>
<FDT-Instance xmlns:xsi=″http://www.w3.org/2001/XMLSchema-instance″
xmlns:fl=″http://www.example.com/flute″
xsi:schemaLocation=″http://www.example.com/flute-fdt.xsd“ Expires=″2890842807″>

<File

Content-Location=″http://www.operator.com/config/wap-settings.xdm″
TOI=″Y″
Content-Type=″application/vnd.syncml.dm+wbxml″
Content-Length=″3000″/>

... other File-elements ...

</FDT-Instance>

ALC transport object 314 includes a TOI indicator 316 and a concatenated set of OMA DM messages 318. This object's corresponding FLUTE FDT entry is represented as:

<?xml version=″1.0″ encoding=″UTF-8″?>
<FDT-Instance xmlns:xsi=″http://www.w3.org/2001/XMLSchema-instance″
xmlns:fl=″http://www.example.com/flute″
xsi:schemaLocation=″http://www.example.com/flute-fdt.xsd“ Expires=″2890842807″>

<File

Content-Location=″http://www.operator.com/config/ims-settings″
TOI=″Z″
Content-Type=″application/vnd.omadm-message-large-object″
Content-Encoding=″gzip″
Content-Length=″42000″/>

... other File-elements ...

</FDT-Instance>

As indicated by this FDT entry, the concatenated objects, as a whole, may be compressed. Accordingly, this compression may be in accordance with various schemes or algorithms, such as gzip.

FIG. 3B illustrates transport object 314 in greater detail. In particular, this diagram shows that transport object 314 may be viewed as a large object container 320. To represent itself as such, object 314 has a special header 322. This header may be represented in various manners, such as in the extensible markup language (XML). For instance, header 322 may be indicated as:

Large_Object_Container_Header {

| | |
|---|---|
| n_o_dm_messages | uimsbf |

for(i=0; i< n_o_dm_messages; i++) {

| | |
|---|---|
| dm_message_offset[i] | uimsbf |
| dm_message_type[i] | uimsbf |

}

}

As a whole, large object container 320 may be represented as:

Large_Object_Container {

Large_Object_Container_Header {

| | |
|---|---|
| n_o_dm_messages | uimsbf |

for(i=0; i< n_o_dm_messages; i++) {

| | |
|---|---|
| dm_message_offset[i] | uimsbf |
| dm_message_type[i] | uimsbf |

}

}
Large_Object_Container_Payload {

for(i=0; i< n_o_dm_messages; i++) {

| | |
|---|---|
| OMA_DM_Message[i] | bitstring |

}

}

}

In the above representations, uimsbf denotes an unsigned 32 bit integer (most significant bit first), and bitstring denotes an array of bits.

V. Exemplary Architecture

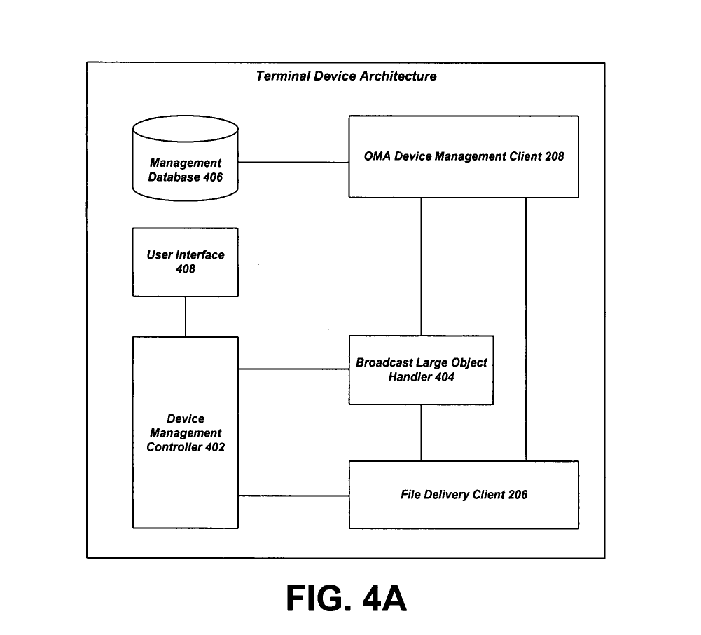

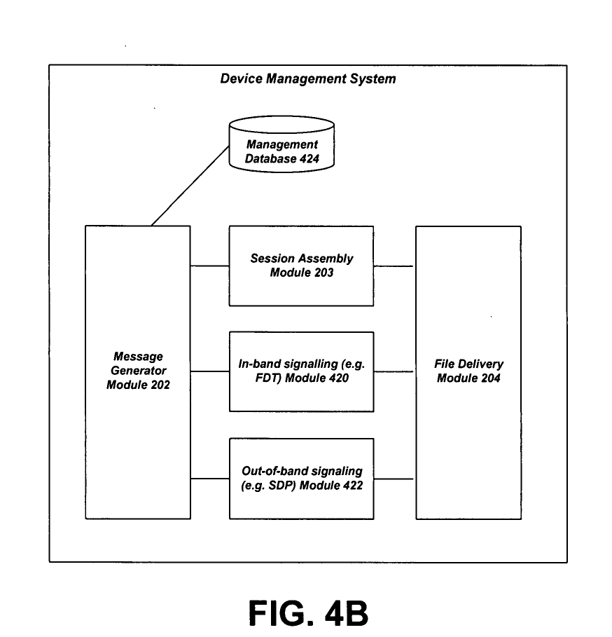

The terminal device implementation described above with reference to FIG. 2 includes a file delivery client 206 and device management client 208. FIG. 4A is a block diagram showing an exemplary terminal device implementation in greater detail. In addition to including file delivery client 206 and device management client 208, the implementation of FIG. 4A includes a device management controller 402, a broadcast device management object handler 404, a management database 406, and a user interface 408.

Device management controller 402 controls the terminal device for the reception of device management messages. Broadcast device management object handler 404 handles large objects by extracting individual messages from such messages and forwarding these messages to device management client 208 for processing. In embodiments, handler 404 may be employed to handle any other object or situation in which the terminal device resident feedback function in the absence or unavailability of interaction with a remote server or system. Management database 406 stores device management messages, managed parameters, configurations, applications, and the like.

User interface 408 provides for interaction with a user. Accordingly, user interface 408 may include output devices, such as a display, and audio speakers. In addition, user interface 408 may include input devices, such as a keypad, touchscreen, buttons, and a microphone.

Device management client 208 is shown in FIG. 4A as being an OMA device management client. However, this is shown for purposes of illustration, and not in limitation. In fact, other device management protocols and schemes may be employed.

FIG. 4B is a block diagram showing a device management system in greater detail. As described above with reference to FIG. 2, this implementation includes message generator module 202, session assembly module 203, and file delivery module 204. However, the implementation of FIG. 4B further includes an in-band signaling module 420, an out-of-band signaling module 422, and a management database 424.

In-band signaling module 420 generates descriptive information regarding assembled sessions, that themselves are also part of the session. For example, such descriptive information may include a FLUTE FDT. Out-of-band signaling module 422 generates descriptive information regarding assembled sessions, that themselves are not part of the session. Examples of such descriptive information include SMS message, ESG information, SDP messages, and the like. As shown in FIG. 4B, information generated by modules 420 and 422 may be distributed to terminal devices across various networks. This distribution may be through file delivery module 204 or other delivery mechanisms (not shown). Management database 424 may store various management information, such as DM messages, as well as session objects.

In embodiments of the present invention, the modules described with reference to FIGS. 2, 4A, and 4B may be implemented in software, firmware, hardware or by any combination of various techniques. For example, in some embodiments, the present invention may be provided as a computer program product or software which may include a machine or computer-readable medium having stored thereon instructions which may be used to program a computer (or other electronic devices) to perform a process according to the present invention. In other embodiments, steps of the present invention might be performed by specific hardware components that contain hardwired logic for performing the steps, or by any combination of programmed computer components and custom hardware components.

Moreover, in embodiments, the modules and elements shown in these drawings may be implemented together in an integrated fashion, or even provided as separate devices (e.g., separate servers and/or clients across network(s)).

VI. Operation

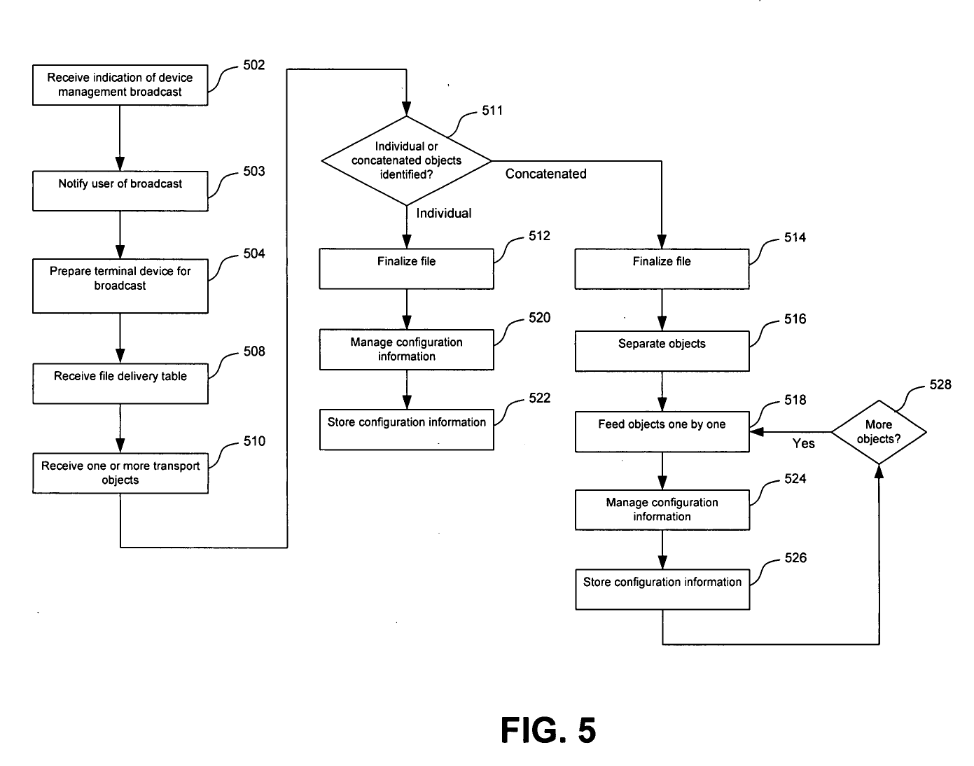

FIG. 5 is a flowchart illustrating a sequence of operational steps according to aspects of the present invention. This sequence is shown with reference to the terminal device implementation of FIG. 4A. However, these steps may be performed by alternative terminal device implementations and architectures.

In a step 502, device management controller 402 receives an indication of the existence of a device management broadcast. This indication may be received through various delivery schemes. For instance, step 502 may comprise receiving this indication through an electronic service guide (ESG), a push notification message, a short messaging service (SMS) service, or the like. In embodiments, terminal devices may receive such indications through out-of-band (e.g., return path) communications.

This indication signifies that device management messages (e.g., OMA device management messages) are being delivered over an IP-based broadcast using FLUTE. For instance, this indication may include a pointer to the FLUTE delivery session. This pointer may employ, for example, service discovery protocol (SDP), the extensible markup language (XML), or other techniques.

In further embodiments, the indication received in step 502 may include further information. For instance, the indication may include timing and/or scheduling information regarding the FLUTE delivery session, metadata regarding to what the FLUTE transmission pertains (e.g., device settings, applications, etc.), and metadata expressing the intended target terminals (e.g., by terminal model, host operator, etc.). Moreover, the indication received in step 502 may include any combination of this information. Although the present invention is described in terms of FLUTE, any packet oriented protocol may be employed.

In an optional step 503, the terminal device's user may be prompted or notified of the indication received in step 502. With reference to FIG. 4A, this indication is provided through user interface 408.

In a step 504, the terminal device prepares for the device management broadcast reception. For instance, device management controller 402 may configure file delivery client 206 based on the indication of the device management broadcast received in step 502. This step may include sending one or more configuration access parameters to file delivery client 206. In addition, device management controller 402 may configure broadcast device management object handler 404 with “feed-speed or max command throughput” parameters that are suitable (or acceptable) for the reception of device management messages by device management client 208.

Using the configuration access parameters received from device management controller 402, steps 508 and 510 are performed. In step 508, file delivery client 206 receives a file delivery table (e.g., a FLUTE FDT table) that corresponds to the device management broadcast. The file delivery table identifies one or more transport objects, each conveying one or more device management messages (e.g., OMA DM messages). In addition, the file delivery table provides descriptive information that, for instance, indicates the file type for each of these transport objects. Accordingly, step 508 may further comprise file delivery client 206 identifying a type for each of the objects indicated in the file delivery table.

In step 510, file delivery client 206 receives one or more transport objects (e.g., ALC transport object(s)) that are indicated in this file delivery table. In embodiments of the present invention, step 510 while step 508 is bypassed. When this occurs, file delivery client 206 may identify the transport object(s) as being device management message(s). This identification may be performed through the use of techniques that allow such transport objects to be identified as conveying device management message(s). Examples of such techniques include the use of predetermined TOI(s), ALC header extension(s), and/or other indication schemes.

Also, in further embodiments, step 510 may be performed before step 508. In such embodiments, file delivery client 206 temporarily stores the transport object(s) received in this step until their corresponding descriptive information (e.g., file type indications) for each of these transport objects is received in step 508.

As stated above, file or transport object types may be identified by file delivery client 206 in steps 508 and/or 510. Thus, as indicated by a step 511, if it is determined through this identification that the file type is an individual DM message or an individual compressed DM message, then file delivery client 206 finalizes (e.g., extracts and potentially decompresses) the identified object(s) and passes them to device management client 208 in a step 512. Examples of such messages include an OMA DM message application/vnd.syncml.dm+xml and a compressed OMA DM message application/vnd.syncml.dm+wbxml.

Next, in a step 520, device management client 208 applies (or manages) the parameters, configurations, applications, and the like that have been received from file delivery client 206 and/or broadcast device management object handler 404. Also, in a step 522, device management client 208 may store this information in management database 406.

However, if it is determined (in step 511) through the aforementioned identification that the file type is a concatenated set of device management messages (also referred to as a large object), file delivery client 206 finalizes the object (e.g., extracts and potentially decompresses) (for example the content-encoding, etc.) and passes the large object to broadcast device management object handler 404 in a step 514.

As shown in FIG. 5, step 514 is followed by a step 516. In this step, broadcast device management object handler 404 separates the individual messages contained in the large object it received from file delivery client 206.

Then, in a step 518, broadcast device management object handler 404 mimics the operation of file delivery module 204 and feeds the contained DM messages one by one. In embodiments, the transfer of successive messages occur when object handler 404 receives an indication (or trigger) from device management client 208 that the previous object was successfully received and processed (for example, as described below with reference to step 524).

In a step 524, device management client 208 applies (or manages) the parameters, configurations, applications, and the like that have been received from file delivery client 206 and/or broadcast device management object handler 404. Also, in a step 526, device management client 208 may store this information in management database 406. Following, step 526, it is determined whether there are more objects to be fed by handler 404. If so, then operation returns to step 518.

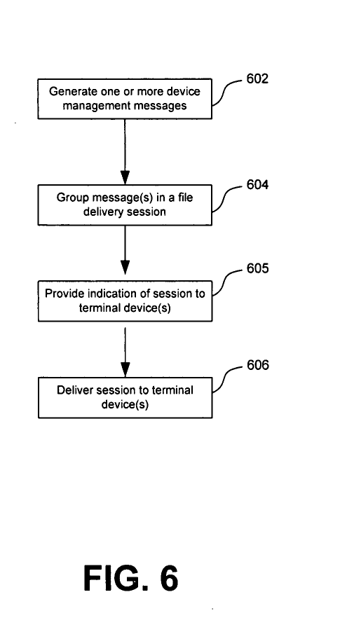

FIG. 6 is a flowchart of an operational sequence involving the generation and distribution of device management messages. Accordingly, in embodiments, this sequence may be performed by device management system 108. As shown in FIG. 6, this sequence includes a step 602 in which one or more device management messages are generated. With reference to FIG. 2, this step may be performed by message generator module 202.

In a step 604, the one or more device management messages are grouped in a file delivery session, such as a FLUTE session. This session is delivered to one or more terminal devices in a step 606. Accordingly, these steps may be performed by file delivery module 204.

The sequence of FIG. 6 may also include a step 605. In this step, an indication of the file delivery session is provided to one or more terminal devices. This indication may be in various forms, such as through SMS message(s), and/or in ESG(s). Accordingly, this step may be performed by file delivery module 204 and/or one or more content servers 106.

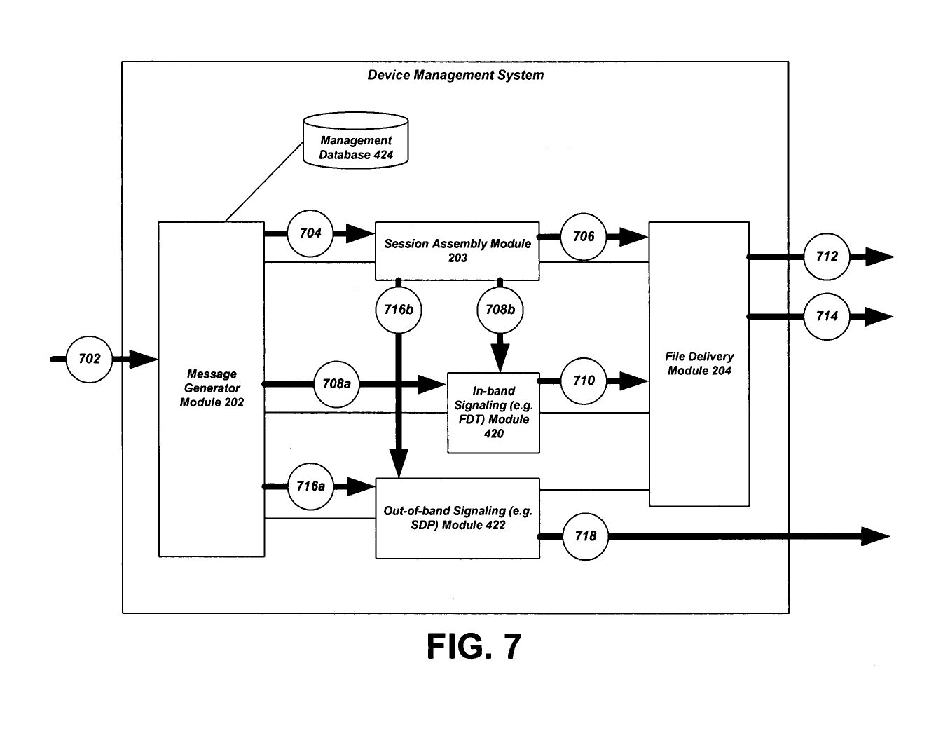

FIG. 7 is a diagram showing a sequence of steps according to aspects of the present invention. These steps are shown with reference to the implementation of FIG. 4B. However, these steps may be performed by other implementations. As shown in FIG. 7, management commands and management data are sent to message generator module 202 in a step 702.

Next, in a step 704, these commands and data are sent to session assembly module 203 for assembly (or encapsulation) into a file delivery session (e.g., a FLUTE session). Accordingly, in a step 706, encapsulated device management messages are sent to file delivery module 204 for transmission. This transmission is shown by step 712.

FIG. 7 shows steps 708 and 710. In step 708, information regarding the delivery session is provided to in-band signaling module 420. In embodiments, this step comprises a step 708a in which the device management messages are sent to module 420, and a step 708b in which the encapsulated messages are sent to module 420. As a result of step 708, step 710 is performed. In this step, module 420 generates and sends a file delivery table to file delivery module 204. Following this step, module 204 transmits the file delivery table in step 714.

As an alternative (or an addition) to steps 708 and 710, steps 716 and 718 may be performed. In step 716, information regarding the delivery session is provided to out-of-band signaling module 422. In embodiments, this step comprises a step 716a in which the device management messages are sent to module 422, and a step 716b in which the encapsulated messages are sent to module 422. As a result of step 706, step 718 is performed. In this step, module 422 generates and out of band signaling regarding the session (e.g., SDP, SMS, XML, ESG, etc.) for delivery to terminal devices.

VII. Exemplary Computer System

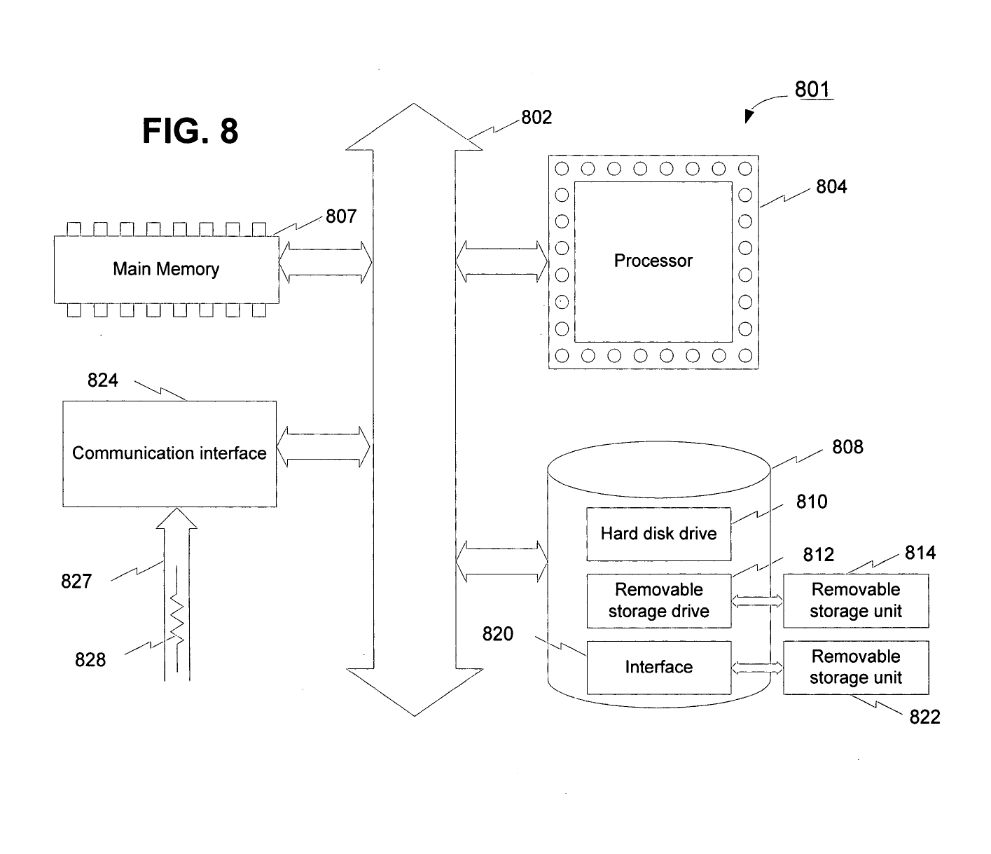

The above description involves various devices, such as device management system 108 and may be implemented with one or more computer systems. An example of a computer system 801 is shown in FIG. 8. Computer system 801 represents any single or multi-processor computer. Single-threaded and multi-threaded computers can be used. Unified or distributed memory systems can be used.

Computer system 801 includes one or more processors, such as processor 804. One or more processors 804 can execute software implementing the processes described above. Each processor 804 is connected to a communication infrastructure 802 (for example, a communications bus, cross-bar, or network). Various software embodiments are described in terms of this exemplary computer system. After reading this description, it will become apparent to a person skilled in the relevant art how to implement the invention using other computer systems and/or computer architectures.

Computer system 801 also includes a main memory 807 which is preferably random access memory (RAM). Computer system 801 may also include a secondary memory 808. Secondary memory 808 may include, for example, a hard disk drive 810 and/or a removable storage drive 812, representing a floppy disk drive, a magnetic tape drive, an optical disk drive, etc. Removable storage drive 812 reads from and/or writes to a removable storage unit 814 in a well known manner. Removable storage unit 814 represents a floppy disk, magnetic tape, optical disk, etc., which is read by and written to by removable storage drive 812. As will be appreciated, the removable storage unit 814 includes a computer usable storage medium having stored therein computer software and/or data.

In alternative embodiments, secondary memory 808 may include other similar means for allowing computer programs or other instructions to be loaded into computer system 801. Such means can include, for example, a removable storage unit 822 and an interface 820. Examples can include a program cartridge and cartridge interface (such as that found in video game devices), a removable memory chip (such as an PROM, EPROM, EEPROM, flash memory, etc.) and associated socket, and other removable storage units 822 and interfaces 820 which allow software and data to be transferred from the removable storage unit 822 to computer system 801.

Computer system 801 may also include one or more communications interfaces 824. Communications interfaces 824 allow software and data to be transferred between computer system 801 and external devices via communications path 827. Examples of a communications interface 824 include a modem, a network interface (such as an Ethernet card), a communications port, etc. Software and data transferred via communications interfaces 824 are in the form of signals 828 which can be electronic, electromagnetic, wireless, optical or other signals capable of being received by communications interfaces 824, via communications paths 827. Note that communications interfaces 824 provide a means by which computer system 801 can interface to a network such as the Internet.

The present invention can be implemented using software running (that is, executing) in an environment similar to that described above with respect to FIG. 8. In this document, the term “computer program product” is used to generally refer to removable storage units 814 and 822, a hard disk installed in hard disk drive 810, or a signal carrying software over a communication path 827 (wireless link or cable) to communication interfaces 824. A computer useable medium can include magnetic media, optical media, or other recordable media, or media that transmits a carrier wave or other signal. These computer program products are means for providing software to computer system 801.

Computer programs (also called computer control logic) are stored in main memory 807 and/or secondary memory 808. Computer programs can also be received via communications interfaces 824. Such computer programs, when executed, enable the computer system 801 to perform the features of the present invention as discussed herein. In particular, the computer programs, when executed, enable the processor 804 to perform the features of the present invention. Accordingly, such computer programs represent controllers of the computer system 801.

The present invention can be implemented as control logic in software, firmware, hardware or any combination thereof. In an embodiment where the invention is implemented using software, the software may be stored in a computer program product and loaded into computer system 801 using removable storage drive 812, hard drive 810, or interface 820. Alternatively, the computer program product may be downloaded to computer system 801 over communications paths 827. The control logic (software), when executed by the one or more processors 804, causes the processor(s) 804 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

VIII. Conclusion

While various embodiments of the present invention have been described above, it should be understood that they have been presented by way of example only, and not in limitation. For instance, although examples have been described involving DVB-T, DVB-H, and cable technologies, other technologies are within the scope of the present invention. For instance, the techniques of the present invention may be applied in various cellular and short-range wireless communications networks.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method, comprising:
(a) receiving an indication of a device management broadcast, wherein the device management broadcast is in the form of a file delivery session;
(b) receiving a transport object of the device management broadcast, the transport object including one or more device management messages; and
(c) applying the one or more device management messages in a terminal device.

2. The method of claim 1, wherein the file delivery session is a FLUTE session.

3. The method of claim 1, wherein the transport object includes a plurality of concatenated device management messages.

4. The method of claim 3, wherein each of the concatenated device management messages is compressed according to a compression scheme.

5. The method of claim 4, wherein compression scheme is gzip.

6. The method of claim 1, wherein step (a) comprises receiving the indication from an electronic service guide (ESG).

7. The method of claim 1, wherein step (a) comprises receiving the indication from one or more short messaging service (SMS) messages.

8. The method of claim 1, wherein step (a) comprises receiving the indication from one or more session description protocol (SDP) messages.

9. The method of claim 1, storing information from the one or more device management messages in the terminal device.

10. A terminal device, comprising:
a controller configured to receive an indication of a device management broadcast, wherein the device management broadcast is in the form of a file delivery session;
a file delivery client configured to receive a transport object of the device management broadcast, the transport object including one or more device management messages; and
a device management client configured to apply the one or more device management messages in the terminal device.

11. The terminal device of claim 10, wherein the file delivery session is a FLUTE session.

12. The terminal device of claim 10, further comprising a database configured to store information from the one or more device management messages in the terminal device.

13. A method comprising:
(a) generating one or more device management messages;
(b) grouping the one or more device management messages in a file delivery session; and
(c) delivering the file delivery session to one or more terminal devices.

14. The method of claim 13, further comprising:
(d) providing an indication of the file delivery session to the one or more terminal devices.

15. The method of claim 14, wherein step (d) comprises indicating the file delivery session in an electronic service guide (ESG).

16. The method of claim 14, wherein step (d) comprises indicating the file delivery session in one or more short messaging service (SMS) messages.

17. The method of claim 14, wherein step (d) comprises indicating the file delivery session in one or more session description protocol (SDP) messages.

18. The method of claim 13, wherein step (b) comprises compressing at least one of the device management messages.

19. The method of claim 13, wherein the one or more device management messages includes a plurality of device management messages, and wherein step (b) comprises concatenating the plurality of device management messages into a single object of the file delivery session.

20. The method of claim 13, wherein the file delivery session is a FLUTE session.

21. An apparatus, comprising:
a device management module configured to generating one or more device management messages;
a session assembly module configured to group the one or more device management messages into a file delivery session; and
a delivery module configured to deliver the file delivery session to one or more terminal devices.

22. The apparatus of claim 21, further comprising:
an out-of-band signaling module configured to generate an out-of-band indication of the file delivery session to the one or more terminal devices.

23. The apparatus of claim 22, wherein the out-of-band indication employs one or more session description protocol (SDP) messages.

24. The apparatus of claim 22, wherein the out-of-band indication is in an electronic service guide (ESG).

25. The apparatus of claim 22, wherein the out-of-band indication includes one or more short messaging service (SMS) messages.

26. The apparatus of claim 21, wherein the session assembly module is further configured to compress at least one of the device management messages.

27. The apparatus of claim 21, the one or more device management messages includes a plurality of device management messages, and wherein the session assembly module is further configured to concatenate the plurality of device management messages into a single object of the file delivery session.

28. The apparatus of claim 21, wherein the file delivery session is a FLUTE session.

29. A computer program product comprising a computer useable medium having computer program logic recorded thereon for enabling a processor in a computer system to operate a device, the computer program logic comprising:
program code for enabling the processor to receive an indication of a device management broadcast, wherein the device management broadcast is in the form of a file delivery session;
program code for enabling the processor to receive a transport object of the device management broadcast, the transport object including one or more device management messages; and
program code for enabling the processor to apply the one or more device management messages in a terminal device.

30. A computer program product comprising a computer useable medium having computer program logic recorded thereon for enabling a processor in a computer system to operate a device, the computer program logic comprising:
program code for enabling the processor to generate one or more device management messages;
program code for enabling the processor to group the one or more device management messages in a file delivery session; and
program code for enabling the processor to deliver the file delivery session to one or more terminal devices
